(19) United States
(12) Patent Application Publication
(10) Pub. No.: US 2021/0386040 A1
(43) Pub. Date: Dec. 16, 2021

(54) Recirculating Culture System, Use of a Recirculating Culture System and Method for Operating a Recirculating Culture System

(71) Applicants: Aline Hock, Warwerort (DE); Biniam Samuel, Warwerort (DE)

(72) Inventors: Aline Hock, Warwerort (DE); Biniam Samuel, Warwerort (DE)

(21) Appl. No.: 17/288,931

(22) PCT Filed: Nov. 13, 2019
(86) PCT No.: PCT/DE2019/100980

§ 371 Date: Apr. 27, 2021

(30) Foreign Application Priority Data
Nov. 13, 2018 (DE) 10 2018 008 940.2

(51) Int. Cl. A01K 63/04; A01K 63/06; A01K 61/10

(52) U.S. Cl. CPC A01K 63/045; A01K 63/047; A01K 61/85; A01K 61/10; A01K 63/06

(57) ABSTRACT

The invention relates to a recirculating culture system for cultivating and/or breeding aquatic creatures, comprising: a recirculating system for circulating and controlling the temperature of a fluid, wherein the recirculating system has a culture pool (1) for receiving the fluid, a water reservoir (2) for storing the fluid, a temperature-control device (3) designed to supply thermal energy to and/or remove thermal energy from the fluid, a pump system (4) for circulating the fluid, and a filter system (5) for filtering the fluid; as well as a container (6) having at least one internal space (61), wherein the recirculating system is arranged in the at least one internal space (61) of the container (6).

### CROSS REFERENCE TO RELATED APPLICATIONS

This application is the U.S. national stage of International Application No. PCT/DE2019/100980, filed on 2019 Nov. 13. The international application claims the priority of DE 102018008940.2 filed on 2018 Nov. 13; all applications are incorporated by reference herein in their entirety.

### BACKGROUND

The invention relates to a recirculating culture system for cultivating and/or breeding aquatic organisms. The invention further relates to the use of a recirculating culture system and a method for automatically operating a recirculating culture system for cultivating aquatic organisms.

Against the background of a constantly growing world population and the immensely increasing demand for food production that goes hand in hand with it, aquaculture is also becoming more and more important. Especially in recent years, the demand for sustainable food and environmentally friendly solutions has also grown steadily.

Conventional recirculating aquaculture systems typically require partial water exchange, are very energy intensive, large-scale systems. Such systems are not modular and typically include water treatment systems designed to handle a large volume of culture pool water. In large systems, interventions by specially trained personnel are required to maintain the daily activities of the systems e.g., feeding the husbandry organisms. In addition, such systems are typically housed indoors to protect the system from the effects of environmental changes.

Publication EP 2343969 A2 describes a fish tank arrangement, comprising a plurality of fish tanks and a measuring device for detecting at least one water parameter of the holding water within the fish tanks. The indoor fish tank described achieves elevation of the entire fish tank by means of the frame structure, which allows substantial or all of the watery-filed areas to be above the floor of the building on which the frame structure is placed. Process control is provided from a separate equipment room.

Publication DE 20 2017 107 283 U1 discloses an aquaculture system having a culture pool, a tank for rearing feed animals, a tank for rearing plants, and an additional storage tank for the culture water, which are connected via a fluid circuit. The system is constructively complex and not sufficiently shielded against external influences.

Publication DE 10 2010 005 563 B4 describes a management system for operating a rearing device with an aquaculture for the controlled rearing of aquatic organisms, which comprises means for recording actual parameters and in which different actual parameters for both the rearing device and the aquaculture can be recorded by means of the recording means.

Publication DE 10 2010 052 018 A1 relates to a complex nested recirculation process for land-based aquaculture having at least one biologically modifiable resource tank, in which at least one circuit of culture pools, support lines and filter modules is integrated in the free water.

### SUMMARY

It is the object of the invention to provide an improved recirculating culture system for the cultivation and/or breeding of aquatic organisms, which allows a simplified application for the user.

This object is solved with the characterizing features of the first, sixteenth and seventeenth claims. Advantageous embodiments result from the subclaims.

### DETAILED DESCRIPTION

According to the invention, a recirculating culture system is provided for the cultivation and/or breeding of aquatic organisms, comprising
a recirculating system for circulating and controlling the temperature of a fluid, wherein the recirculating system comprises a culture pool for receiving the fluid, a water reservoir for storing the fluid, a temperature-control device adapted to supply thermal energy to and/or extract thermal energy from the fluid; a pump system for circulating the fluid, and a filter system for filtering the fluid, as well as
a container having at least one internal space,
   wherein the recirculating system is arranged in the at least one internal space of the container.

The term “aquatic organisms” means aquatic creatures such as fish, crustaceans, mollusks, corals, and/or plants. Included are both freshwater and saltwater organisms, cold-water- and warm-water-loving organisms, ornamental and edible fish.

The fluid is a fluid suitable for the cultivation and/or breeding of aquatic organisms, in particular water. This may be fresh water or salt water.

The culture pool is used to hold one or more individuals of the aquatic organisms to be cultured and/or grown. The culture pool has a maximum capacity of 3500 L, preferably maximum 2500 L. particularly preferably maximum 1000 L.

Advantageously, the culture pool has a round base. This is preferably circular, i.e. it has a uniform diameter. The base surface can also be elliptical.

The water reservoir preferably has a capacity of 200 L to 1000 L, more preferably 300 L to 800 L.

A pump system is designed to circulate the fluid between the culture pool, water reservoir and filter chambers. The circulation preferably takes pace via pipe guides from the culture pool through one or more first filter chambers of the filter system into the water reservoir and from the water reservoir through one or more second filter chambers of the filter system into the culture pool. In addition, one or more pumps can be arranged in the culture pool to bring about a continuously mixing flow in the culture pool.

A temperature-control device is set up to supply thermal energy to and/or extract thermal energy from the fluid located in the recirculating culture system. This preferably concerns one or more heating rod(s) immersed in the fluid in the water reservoir and/or alternatively or additionally one or more coolers.

The recirculating culture system according to the invention further comprises a container defining an internal space. The container is preferably in the form of an outer shell. Preferably the internal space is contiguous. Alternatively, two or more partial compartments of the internal space may be completely or substantially separated from each other.

In a preferred embodiment, the container has a housing and a lid. Preferably, the housing has a substantially rounded base. The housing is formed as an outer shell to isolate the recirculating culture system as a self-contained module from weather effects and temperature fluctuations. This minimizes changes in the husbandry parameters of the aquatic organisms. This improves the husbandry conditions of the aquatic organisms and protects against diseases, germ transmission and other external influences.

The lid is designed to cover the internal space. Preferably, a device serving to supply the feed into the culture pool is arranged in the lid. This is preferably an automated feeding machine.

In addition, elements illuminating the interior, for example LEDs and/or other illuminants, can he mounted on the inside of the lid and/or on the upper part of the enclosure.

A camera directed into the culture pool may also be located in the lid.

One or more motion and/or pressure sensors can also be arranged in the lid to detect whether the lid is in an open or closed state.

The housing can be designed to be lockable with the lid to prevent unauthorized access to the recirculating culture system. This can be realized, for example, by means of an RFID (radio frequency identification) key. Alternatively, other known identification systems can be used. For example, the lid can also be opened and/or closed by app command from a mobile terminal.

Furthermore, the lid and the housing comprise one or more ventilation and opening channel(s) through which moisture can escape and air can circulate.

In a preferred embodiment, the container has one or more than one container wall penetrated by an opening, wherein the opening and the culture pool are arranged relative to each other such that the culture pool covers the opening when the culture pool is arranged in the container.

If the opening in the container wall extends as far as the lid, at least one web and/or at least one overpass and/or at least one bridge is arranged in the area of the lid covering the opening, which serves to seal off the area above the opening. For this purpose, a groove can be arranged in the web/in the overpass/in the bridge, which groove at least partially accommodates a pool wall of the culture pool covering the opening. Alternatively or additionally, a corresponding seal can be arranged in the web/in the overpass/in the bridge.

Advantageously, this creates a viewing window through which, on the one hand, light can enter the culture pool and/or the other hand, it is easy to see into the culture pool.

Preferably, the culture pool has a transparent pool wall that covers the opening in the pool wall. The transparent pool wall is thus partially visible through the opening in the container wall. The culture pool and the container wall of the container close flush at the viewing window, so that no environmental effects can penetrate into the interior of the recirculating culture system and/or the temperature insulation is impaired.

The wall of the culture pool is preferably made of Plexiglas. In particular, the wall is designed in a food-safe manner. Alternatively, the wall of the culture pool can be made of multiple glazing or thermoglass in order to minimize temperature losses through the viewing window. Alternatively, the wall of the culture pool is formed from a transparent plastic that ensures appropriate insulation.

There may be a cover for the opening (for the viewing window) that can be used to cover the opening (the viewing window) if necessary. This might be necessary if the recirculating culture system is located outdoors and exposed to adverse weather conditions. For example, the cover may be formed of a nonwoven fabric, isoprene, or similar suitable materials. The cover may be part of the recirculating culture system or may be designed separately.

There are embodiments of the invention in which the container wall is not penetrated by an opening. In these embodiments, the container wall is preferably designed in an opaque manner. Advantageously, in this embodiment, images from a camera directed into the interior of the culture pool are transmitted to a display unit arranged on the outside of the tank. This can be done live or with a time delay.

Advantageously, the one or more than one container wall has an insulating material or the one or more than one container wall is formed of an insulating material.

The container wall may consist of one or more layers.

The materials from which the container wall may be formed are preferably weather-resistant and/or temperature-insulating.

The container wall and the container lid can have an insulating effect.

The container wall can be formed from polyethylene or another suitable thermoplastic.

The container wall can be made of natural materials such as cellulose insulation and/or cork and/or wood for example pine, larch or solid or plywood.

The container wall may also comprise commercial insulation materials such as polystyrene, styrofoam, polyurethane or cellular glass.

The container wall may also be a combination of one or more natural materials and/or one or more commercial materials.

In a preferred embodiment, the recirculating culture system further comprises a sensor system arranged in the at least one internal space of the container, wherein the sensor system comprises a temperature sensor, an oxygen sensor, a flow sensor a conductivity sensor, and/or a pH sensor.

The temperature sensor is preferably arranged in the culture pool. Several temperature sensors can also be arranged at different locations in the culture pool. In addition, further temperature sensors can be arranged in the water reservoir and/or in the interior of the container outside the culture pool and water reservoir. Advantageously, the temperature can be reliably detected in the entire area of the recirculating culture system.

In addition, a temperature sensor may be arranged outside the container to sense the ambient temperature outside the recirculating culture system according to the invention.

One or more than one oxygen sensor is preferably arranged in the culture pool and/or in the filter system and/or water reservoir to record the oxygen content. Preferably, water parameters are recorded continuously.

A flow sensor is advantageously arranged immediately upstream or immediately downstream of at least one pump of the pump system to detect the flow through the pump. If there are several pumps in the pump system, a flow sensor is preferably arranged on each of the pumps.

One or more pH sensors and one or more sensors for measuring the respective redox potential of the fluid are preferably arranged in the culture pool and/or in the water reservoir. The salt content and alkalinity of the fluid, as well as any CO₂ enrichment in the culture water, can be recorded via these.

Furthermore, at least a first motion sensor with a detection field located inside the culture pool can be arranged in the housing. The motion sensor can be used to detect the movements and activity patterns of the aquatic organisms present in the culture pool.

In addition, at least one second movement and/or pressure sensor can be arranged on the lid, with the aid of which it can be detected whether and for how long the lid is in an open state.

One or more water level sensors can be present in both the culture pool and the water reservoir. These detect a change in the water level in the fluid-filled pools of the recirculating culture system, which could be triggered, for example, by a leak, but also by too strong/too weak pumping power of one or more pumps of the pump system.

A light sensor can be arranged on the outside of the container to detect the light irradiation, for example by sunlight, on the recirculating culture system according to the invention.

Furthermore, it is possible to arrange an air pressure gauge on the outside of the container, which can detect the air pressure outside the recirculating culture system according to the invention.

One or more conductivity sensors, both in the water reservoir and in the culture pool, can be arranged to detect the conductivity of the fluid.

In a preferred embodiment, the recirculating culture system according to the invention further comprises a control device in the internal space, which is set up to control the recirculating system on the basis of data from the sensor system.

Advantageously, the recirculating system can be adapted directly to changing conditions without the need for time-consuming intervention by a specialist. The well-being and thriving of the aquatic organisms in the recirculating culture system is significantly increased in this way.

Preferably, the recirculating culture system has one or more than one computer circuit board for receiving and transmitting information to and from the control system.

The control device is capable of controlling the individual pumps of the pump system, the temperature-control device, the device for feed supply, one or more air pumps and/or an oxygen mixer for an oxygen supply into the fluid and a device for salt enrichment of the fluid.

If the temperature sensors inside the container register a change in temperature, the control device can activate the temperature-control device and thus automatically cause the fluid in the recirculating system to heat up or cool down.

A temperature change registered by the temperature sensor attached to the outside of the container can also be detected by the control device and result in a control of the temperature system by the control device. For example, an increased outside temperature due to more sunlight may also increase the water temperature of the recirculating culture system. In order to prevent this, an increased outside temperature can already result in a control of the cooler in order to lower the temperature of the fluid again accordingly or to prevent a temperature increase of the fluid.

Increased oxygen consumption by aquatic organisms in the recirculating culture system and/or a decrease in dissolved oxygen in the water can be registered by the oxygen sensor(s). The control device can use this information to control one or more compressed air pumps and/or an oxygen generator to increase the oxygen content in the fluid in the water reservoir and/or in the culture pool again.

To keep the fluid clean, based on fluid parameters such as conductivity, temperature, oxygen content and turbidity, the flow rate, fluid exchange and fluid quantity/retention time in the filter system can be adjusted. The amount of feed and the frequency of feedings can also be regulated and turned off in case of alarm (e.g., in case of registered impurity of the fluid). Oxygen gassing can be increased or decreased depending on ambient, currently measured and programmed fluid parameters.

To prevent increased algae growth in the culture pool, based on solar radiation on the outer shell and into the culture pool, as well as a temperature rise inside the tank, the flow rate and/or flow velocity between the culture pool and the filter system, in particular between the culture pool and a biological filter unit, can be controlled.

To prevent germs, materials or objects from failing into the culture pool or to prevent the lid from not being dosed again after opening, a notification can be sent to a mobile application and/or an acoustic and/or visual alarm signal can be emitted after a predetermined opening time of the lid, preferably after more than 3.5 minutes of opening time, to remind the user to close the lid.

Advantageously, the control device adjusts the control of the recirculating system based on stored user data and/or recorded experience values and/or programmed target values.

For example, programmable daily schedules can be provided to regulate feeding amounts, feeding times, and fluid values such as temperature, salinity, oxygen levels.

The recirculating culture system is designed for automatic fish husbandry preferably according to a predetermined processing program, wherein the husbandry parameters and/or an environmental condition can be measured with regard to condition parameters, such as culture water temperature and/or pH, or can be entered as value(s). Here, a measured value obtained or value entered can be compared with an initial value taken into account in the processing program. Deviations from the initial value can be taken into account by automatic adjustment of the management parameters contained in the processing program, such as optimum temperature range and/or feeding quantity.

In addition, environmental values in particular can also be obtained as environmental parameters by automatic transmission, for example by WLAN, Bluetooth and/or other radio signals from devices located outside the recirculating culture system. Furthermore, such environmental parameters, such as air temperature or sunshine duration, may be requestable by the recirculating culture system for manual input by a user. In the case that a value is not entered, it can also be provided that a default value is used or that the value already used is left.

The length of the fish detected by the camera, which can be used as a measure of the biomass of the species kept in the tank, can be recorded and specified as an initial value in a processing program, if necessary in tabular form and with a certain bandwidth.

The setup of the recirculating culture system in such a way that it can determine the above-mentioned or at least one of the husbandry parameters and/or environmental parameters, and can also act on the processing program, is also achieved in particular in that the recirculating culture system comprises a microprocessor which can carry out appropriate processing of detected signals. This microprocessor preferably also controls the processing program as such. Preferably, and further preferably in the recirculating culture system itself, the microprocessor is assigned a data memory, in particular a non-volatile but preferably modifiable data memory, in which a working program and/or a table of values etc. can be stored. Furthermore, one or more sensors may be provided which are arranged directly in the sensor system and provide the desired values. The determination of the values can also be achieved by the procedures of the recirculating culture system, as also explained above and below, and parameters recorded thereby. Further alternatively or in addition, values can also be entered freely, for example with regard to a query by the recirculating culture system. These can be values such as specific fish species, initial weight of the aquatic organisms used, temperature of the system of origin, etc. Thus, sensor-based collection of husbandry data is not limited to collection occurring prior to and/or at the start of husbandry. Rather, acquisition of a husbandry parameter can also occur during the execution of a husbandry program.

The data from external radio signals, for example weather data, can be used for a gradual adjustment of the culture temperature, for example for warmer episodes. The evaluation of this data can be used, for example, in the long term to optimize the cooling or heating of the culture water. For example, in the event of a temperature change, the normal daily rhythm from the processing program can be gradually adjusted using weather data (data-based) and environmental parameters (sensor-based), for example by adjusting the husbandry temperature.

The camera can be used to determine the existing biomass in the culture pool via the weight/length ratio of the fish. If the biomass has been reduced by partial fishing, the processing program automatically adjusts the feeding quantity (kg/g) to the existing fish stock.

Preferably, the recirculating culture system according to the invention further comprises a display device attached to and/or integrated into an exterior of the container, wherein the control device is further adapted to output, by means of the display device, one or more indications of a system state of the recirculating system.

Preferably, the display device comprises a display.

Advantageously, this allows information regarding the system status to be called up directly on the recirculating culture system. In particular, this is done via a user-friendly, intuitive interface.

Via a gateway, both the control device and the display device can communicate with a cloud. Via the cloud, the system can, for example, retrieve the weather forecast from the Internet and a preparation of the recirculating culture system for a certain weather situation can already be made. For example, a cooling process can already start in the early morning hours if increased solar radiation is expected for the day.

Advertisements or the like can also be displayed via the display device or, alternatively, via additional display elements.

In particular, the display device has at least three, preferably at least five, more preferably at least 10 touch-controlled light components.

In another preferred embodiment, the display device has at least four LED plates.

These can be transparent LED displays.

Alternatively, the container can be covered with LED panels over part of its outer surface or throughout as much of it as possible. Through this digital and visual source, further socio-interactive aspects are linked to the fish farm.

For example, it can be used to encourage people and children to interact with the recirculating culture system set up. Educational, promotional or live content such as a livestream from the culture pool can be shown. This avoids disturbance to aquatic organisms in the culture pool and links human interaction with urban aquaculture.

Advantageously, the control device can respond directly to changing process and/or environmental conditions of the recirculating culture system according to the invention without the need for intervention and regulation by a user.

In particular, the control device is further adapted to generate and/or transmit a message according to a network communication protocol, wherein the message comprises one or more than one indication of a system state of the recirculating system and/or is addressed to a mobile terminal.

For example, if the oxygen reading in the culture pool falls below a species-specific defined threshold, sending a message to a mobile terminal and/or an audible and/or visual alarm signal can occur.

The measured values of the moisture sensor and the water-level sensor can be compared with defined threshold values by the control device. In the event of deviations, a notification can be sent to a mobile application and/or an acoustic and/or visual alarm signal can be emitted. In addition, all or most of the electronic applications (for example, except for the water aeration) can be throttled or adjusted.

If the temperature sensors inside the container and on its outside register a sharp rise in temperature, there may be an electronic defect and/or a fire and/or overheating of certain system components. For example, if the temperature sensor inside the container registers a dry-bulb temperature greater than 30° C. or a gradual increase greater than 10° C. in a very short period of time, preferably less than 10 minutes, more preferably less than 5 minutes, a notification may be sent to a mobile application and/or an audible and/or visual alarm signal may be emitted. In addition, all or most of the electronic applications (for example, except for water aeration) may be throttled or stopped to prevent further damage.

To register an electronic defect and/or fire, a smoke detector may be provided inside the container.

One or more weight sensors may also be arranged on the feed supply device. For example, if the control device registers a presence of less than one-third of the required feed in the feed supply device, a notification may be sent to a mobile application and/or an audible and/or visual alarm signal may be emitted.

In the event of a power failure, a notification can also be sent to a mobile application and/or an acoustic and/or visual alarm signal can be emitted. For example, a power failure may be detected by a voltmeter and/or tachometer. In addition, all or most of the electronic applications (for example, except for water aeration) can be throttled or stopped.

Advantageously, a battery or an emergency unit or a storage medium is arranged, via which a supply is preferably ensured for at least 60 minutes, particularly preferably at least 120 minutes. This period is considered standard for initiating repair measures and/or emergency measures.

The ability of the control device to generate and/or transmit a message, as well as the continued aeration of the culture pool, advantageously minimizes the times during which a potential fault goes unnoticed by the user and allows for prompt repair and damage-free correction of the source of the fault.

Preferably, the filter system has one or more than one anaerobic biofilter and one or more than one aerobic biofilter.

The one or more than one anaerobic biofilter is preferably cylindrical in shape. The one or more than one aerobic biofilter is preferably connected directly or indirectly to the culture pool.

Preferably, the pump system comprises at least one pump that receives fluid from the one or more than one anaerobic biofilter and pumps it to one or more than one aerobic biofilter. The fluid that has passed through the filter system is returned to the water reservoir.

Particularly preferably, the one or more than one anaerobic biofilter has two or more than two anaerobic biofilter chambers and the one or more than one aerobic biofilter has six or more than six aerobic biofilter chambers. This ensures optimal nutrient processing and constant water quality.

The innovative filtration system ensures optimization of the nitrite and ammonium content accumulated in the recirculating system through a combination of multi-chamber aerobic and anaerobic biofilters, as well as automated control.

A camera is also arranged inside the container, the detection field of which is essentially located inside the culture pool. Such a camera can also be arranged directly inside the culture pool and/or lid. Via automatic image evaluation of the data captured by the camera, information can be collected regarding the growth and activity of the aquatic organisms present in the culture pool. Based on this information, for example, an optimal time for harvesting can be adjusted. If the camera detects feed on the bottom of the culture pool, the feed supply device can be controlled in such a way that the feed supply is reduced or interrupted. In this way, the water quality is kept high and no resources, e.g. feed, are unnecessarily consumed.

An adjustment of the program sequence can be made based on the husbandry parameters, for example, by evaluating the camera data. This can be entered by the user or automatically adjusted by the automatic program.

Based on the camera data, the biomass of the aquatic organisms, i.e. weight and number of animals, can be determined. If there is a removal of individual organisms (partial slaughter), the feed quantity is adjusted to the reduced biomass and the feed quantity is reduced proportionally to the stocking density.

Based on the camera data, there may be an adjustment to the harvest time as faster growth or higher initial weight will result in the desired optimal final weight being reached sooner.

The camera can also register turbidity of the fluid, for example due to algae infestation.

Based on the movements, as well as the activity pattern of the aquatic organisms in the culture pool and the environmental conditions, the husbandry parameters can be adjusted to optimize the welfare of the aquatic organisms in the culture pool, i.e. to reduce their stress.

Exterior lighting can he arranged statically or dynamically on the outside of the container. This can be controlled interactively, for example, by touch and/or motion sensors and/or by an on/off switch and/or by a timer.

In addition, advertisements can be arranged on the outside of the container. Conceivable would be advertising displays in digital or printed form. Also conceivable would be a digital all-encompassing LED display on the outside of the container, which transmits images from a camera from inside the culture pool, and/or displays video recordings or live images and/or advertising materials.

In addition, plant growth containers can be arranged on the outside of the container, to which nutrients can be supplied manually or automatically from the culture pool of the recirculating culture system according to the invention. Ornamental plants and/or edible plants and/or other useful plants can be planted in the plant growth containers. Furthermore, other devices such as seating, solar panels or similar additional features can be linked to the outer shell.

The object is further solved by using a recirculating culture system according to the invention for the cultivation and/or breeding of aquatic organisms.

The object is further solved by a method for operating a recirculating culture system according to the invention, comprising the steps of:
introducing aquatic organisms into the recirculating culture system:
bringing the recirculating system to an operating point in accordance with a requirement for cultivating and/or breeding aquatic organisms, such that the recirculating system temperature-controls, recirculates, and/or oxygenates the fluid.

The term “aquatic organisms” means aquatic creatures such as fish, crustaceans, mollusks, corals, and/or plants. Included are both freshwater and saltwater organisms, cold and warm water-loving organisms, ornamental and edible fish.

The fluid present in the recirculating system is a fluid suitable for the cultivation and/or breeding of aquatic organisms, in particular water. This can be fresh water or salt water.

A working point according to a prerequisite for the cultivation and/or breeding of aquatic organisms means a process state in which optimal or near-optimal conditions for the cultivation and/or breeding of aquatic organisms exist. This is described by a certain temperature of the fluid, a certain feeding rate and amount, a certain salt content of the fluid, a certain oxygen content of the fluid, a certain exposure of the culture pool, as well as other parameters known to the person skilled in the art.

The fluid is circulated by means of a pump system. The temperature of the fluid is controlled by means of a temperature-control device. Several sensors record the process and/or environmental parameters of the recirculating culture system.

A control device receives the data from the various sensors and evaluates them. Based on the evaluation and/or on preset set points, the control device controls various process components of the recirculating system, such as the individual pumps of the pump system, the temperature-control device, a device for the feed supply, one or more air pumps and/or an oxygen generator for an oxygen supply to the fluid and, for example, a device for salt enrichment of the fluid.

Advantageously, the recirculating system can be adapted directly to changing conditions without the need for time-consuming intervention by a specialist. The well-being and thriving of the aquatic organisms in the recirculating culture system is significantly increased in this way. The recirculating system operated by the method according to the invention is advantageously automatic and self-sufficient.

The fluid is preferably circulated from the culture pool via one or more first filters of the filter system into the water reservoir and from the water reservoir via one or more second filters of the filter system into the culture pool. The circulation takes place in particular via pipes and conduits.

In addition, a flow in the culture pool can be brought about by means of one or more than one pump in the culture pool.

Preferably, the control device brings the recirculating culture system to the operating point according to a prerequisite for cultivating and/or breeding the aquatic organisms.

The control device can either be programmed by the user or the control device can control the recirculating culture system based on factory settings/presets and thus automatically bring the recirculating culture system to the operating point according to a prerequisite for cultivating and/or breeding of aquatic organisms.

Preferably, the method according to the invention further comprises the step of
removing the aquatic organisms, wherein in the period between the introduction and the removal the recirculating system remains in the interior of the container.

Advantageously, the control device controls the recirculating culture system largely autonomously. Only little work, such as regular refilling of the feed by the user, is required during a cultivation period.

At the end of a cultivation period, comprehensive cleaning of the recirculating culture system by the user is necessary.

In the method according to the invention, one or more stocking cycles for the rearing/husbandry of aquatic organisms are cared out automatically, in particular by means of an automatic program. The species-specific husbandry parameters (e.g. species-specific temperature range) and the environmental parameters (e.g. outside temperature) are recorded by the measuring sensors and automatically compared with the automatic program and external data (e.g. via WLAN) and, if necessary, regulatory measures are taken by the control system. This represents a unique method in the field of recirculating aquaculture, as it enables the end user to operate an automatic acting breeding system for the first time. In this way, fish farming can be made possible for an interested group of customers.

Input and control by the user are preferably carried out via a display or other suitable interactive touch elements.

The feeding regime is adjusted based on the husbandry temperature and the oxygen content in the culture water. It the oxygen content is too low or if the husbandry temperatures are too high or too low, the program sequence is regulated by reducing the amount of feed and gradually dimming the lighting in the culture pool.

Based on the husbandry parameters, further program adjustments are made. Based on the camera data, the biomass of the fish, weight and number of animals are determined. If individual fish are removed (partial slaughter), the feed quantity is adjusted to the reduced biomass. Based on the camera data, there may be an adjustment of the harvest time, because the desired/optimal final weight is reached earlier due to faster growth or higher initial weight.

Advantageously, the recirculating culture system according to the invention and the method according to the invention reduce the technical requirements for a user of the recirculating culture system.

Continuous water purification, stable water parameters such as temperature and water chemistry allow particularly temperature-sensitive and/or husbandry intensive species such as juvenile fish, mother pairs or ornamental fish to be kept in an easily manageable and continuously optimized manner.

The constant maintenance of optimum husbandry conditions for the aquatic organisms in the recirculating culture system according to the invention is advantageously achieved while conserving resources. This is achieved with particularly efficient water and energy consumption.

It is particularly advantageous that the recirculating culture system according to the invention is a circumferentially and temperature isolated system. By isolating the husbandry environment including technical components from environmental influences, interaction with the living environment (wildlife, parasites and bacteria) as well as the inorganic environment (soil, groundwater, weather and temperature fluctuations) is prevented compared to open fish culture systems (e.g. partial recirculating systems and/or flow-through systems).

This serves to protect the husbandry organisms by achieving improved husbandry conditions, as well as avoiding diseases and germ transmission. It reduces resource consumption (e.g. energy, feed, water use) which is attempted in other prior-art applications by external heated sheds and by means of disinfectants. All this is achieved in this technical approach by individually-isolated husbandry systems.

The recirculating culture system according to the invention enables a modular and optionally expandable design in indoor and outdoor areas. It features a temperature-insulated, highly automated and dosed recirculating system that can be controlled by using IoT (Internet of Things) and a mobile application, thus reducing effort and resources. IoT advantageously corresponds to the control system, as the control is preferably connected to a cloud by means of a gateway.

The method according to the invention is characterized by a unique automated and thus customer-oriented aspect. It exhibits a wide variety of customer- and animal-welfare-/husbandry-relevant characteristics as explained above.

Fields of application of the recirculating culture system according to the invention and the method according to the invention are in commercial and private fish farming, in aquaristics and in aquaculture research. The recirculating culture system according to the invention and the method according to the invention are useful for the cultivation of freshwater as well as marine organisms, wherein the aquatic species mentioned above may be the following: Shrimp, marine fish and marine fingerlings, freshwater fish and their fingerlings, mollusk species, algae, and numerous others. This list is not exhaustive.

The invention is explained in more detail below with reference to exemplary embodiments and associated drawings, without being limited thereto.

### BRIEF DESCRIPTION OF THE DRAWINGS

The drawings show as follows:

FIG. 1: schematically shows an embodiment of the closed-lid recirculating culture system according to the invention;

FIG. 2: schematically shows an embodiment of the recirculating culture system according to the invention with the lid open;

FIG. 3: shows a schematic representation of the main components of an embodiment of the recirculating culture system according to the invention;

FIG. 4: shows a circuit diagram of the essential components of one embodiment of the recirculating culture system according to the invention;

FIG. 5: shows a schematic representation of an embodiment of a method for the culture of aquatic organisms, as it can be carried out by means of the recirculating culture system according to the invention;

FIG. 6: shows a schematic representation of feed quantity adjustment using the example of increasing temperature in the culture pool when keeping rainbow trout.

### DETAILED DESCRIPTION OF THE PREFERRED EMBODIMENTS

### Exemplary Embodiment According to the Invention Using the Example of Stress Reduction by Adjusting the Husbandry Parameters Using the Example of Rainbow Trout

The ideal husbandry temperature varies between 13-15° C. (depending on the source) and is maintained continuously throughout the breeding period, depending on environmental parameters (location and external temperatures).

1. If the temperature is more than 16.5° C., feeding is reduced by 50% of the daily feed amount. When the temperature is more than 18° C., automatic feeding is stopped. In this way, the metabolism is throttled and the stress level of the animals is reduced. This is an adapted procedure to reduce stress and mortality.

2. If the amount of oxygen is less than 5.5 mg/l, the amount of feed is reduced by 50% and the water exchange is increased by at least 20%. If the oxygen quantity is less than 4 mg/l, the feed quantity is reduced by 100% and the water exchange is increased by 40%.

3. At high temperature (above the ideal husbandry temperature), the light is gradually dimmed, thus indirectly reducing the activity and stress level of the animals. Dimming of the light is preferably also used in other stress situations.

### Exemplary Embodiment of a Method Using Tilapia as an Example of Stress Reduction by Adjusting Husbandry Parameters

The ideal husbandry temperature varies between 24-26° C. (depending on the source) and is maintained continuously throughout the breeding period, depending on environmental parameters (location and external temperatures).

1. If the temperature is less than 22.5° C., feeding is reduced by 50% of the daily feed amount. When the temperature is less than 20° C., automatic feeding is stopped. In this way, the metabolism is throttled and the stress level of the animals is reduced This is an adapted procedure to reduce stress and mortality.

2. If the temperature is too low/too high (below or above the ideal husbandry temperature) and the ammonium level is high, the light is gradually dimmed, thus indirectly reducing the activity and stress level of the animals. Dimming of the light is preferably also used in other stress situations.

### Exemplary Embodiment of a Method for Preventing Toxic Concentrations of Ammonium from Being Reached

High ammonium levels in the culture water for the husbandry of aquatic organisms can have toxic properties. Therefore, the recirculating culture system according to the invention is equipped with a multi-chamber aerobic and anaerobic biofilter. In addition, a method for preventing toxic concentrations from reaching the culture pool has been developed.

When the ammonium level is 0 to 0.5 mg/l routine water flushing of the filter chambers is performed. If the sensor value for the ammonium level rises to 0.5 to 1 mg/l in the holding tank, then the water exchange rate is increased by 30% from the initial value. The pumping rate is intensified and the lighting of the tank is gradually dimmed down. If the dissolved ammonium in the water continues to rise above 1.5 mg/l and the pH is lower than 6, the alarm system is activated and a push message is sent to the user to perform a manual water change or initiate other measures.

### Exemplary Embodiment of a Method For Stress Reduction of Husbandry Organisms in the Presence of Changing Environmental Parameters, Using Rainbow Trout as an Example

The ideal husbandry temperature of rainbow trout varies between 13 to 15° C. and is maintained continuously within the breeding period. If the temperature in the husbandry system rises sharply, for example, due to solar radiation or a change in air temperatures, this is referred to as the effect of temperature stress on the trout.

In the described method, when the temperature exceeds 16.5° C., feeding is reduced by 50% from the daily feed amount. This prevents additional stimulation of the metabolism of the husbandry organisms. If the temperature rises above 18° C., automatic feeding is stopped. In this way, the metabolism is throttled and the stress level of the animals is reduced until optimal husbandry temperatures are reached again. This is an adapted procedure to reduce stress and mortality.

If the oxygen level is less than 5.5 mg/l, the feed level is reduced by 50% and the water exchange is increased by at least 20%. If the oxygen level is less than 4 mg/l, the feed level is reduced by 100% and the water exchange is increased by 40%. In addition, the light is gradually dimmed, thus indirectly reducing the activity and stress level of the animals.

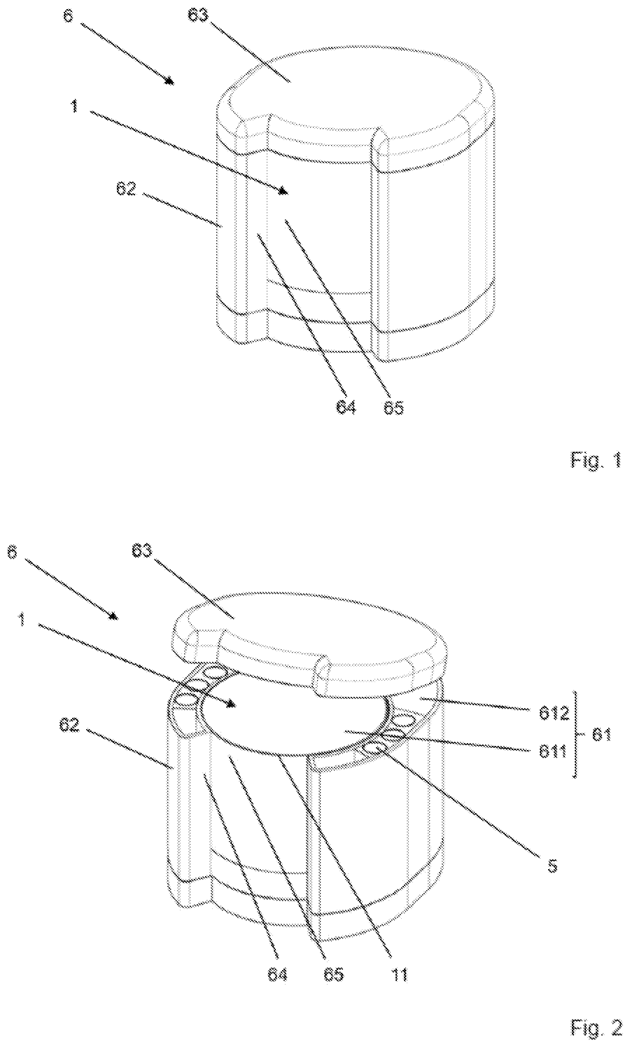

FIG. 1 schematically shows an embodiment of the recirculating culture system according to the invention which comprises a closed lid 63. The recirculating culture system has a container 6 and a culture pool 1, wherein the culture pool 1 is arranged in an internal space of the container 6.

The container 6 has a housing 62 and a lid 63 covering the housing. The housing 62 has a substantially circular base. In particular, the container 6 is formed as an outer shell to isolate the recirculating culture system as a module, to minimize temperature fluctuations, and to protect the system from environmental fluctuations and other external influences.

The container 6 further has a container wall 64 which is pierced by an opening 65. Through the opening 65, the culture pool 1 is visible, which covers the opening 65.

FIG. 2 schematically shows an embodiment of the recirculating culture system according to the invention with the lid 63 open. The container 6 encloses an internal space 61, which in the embodiment shown has a first partial compartment 611 and a second partial compartment 612. The entire recirculating system for circulating and controlling the temperature of a fluid is arranged in the internal space 61. Thereby, the culture pool 1 is arranged in the first partial compartment 611 of the internal space 61 of the container 6, while the filter system 5, as well as the pump system (not shown), the water reservoir (not shown) and the temperature-control device (not shown) are arranged in the second partial compartment 612 of the internal space 61 of the container 6.

The opening 65 arranged in the container wall 64 of the container 6 is covered by a transparent pool wall 11 of the culture pool 1, so that the interior of the culture pool 1 can be viewed through the opening 65.

The sensor system and the control device preferably arranged in the lid 63 are not shown in FIGS. 1 and 2.

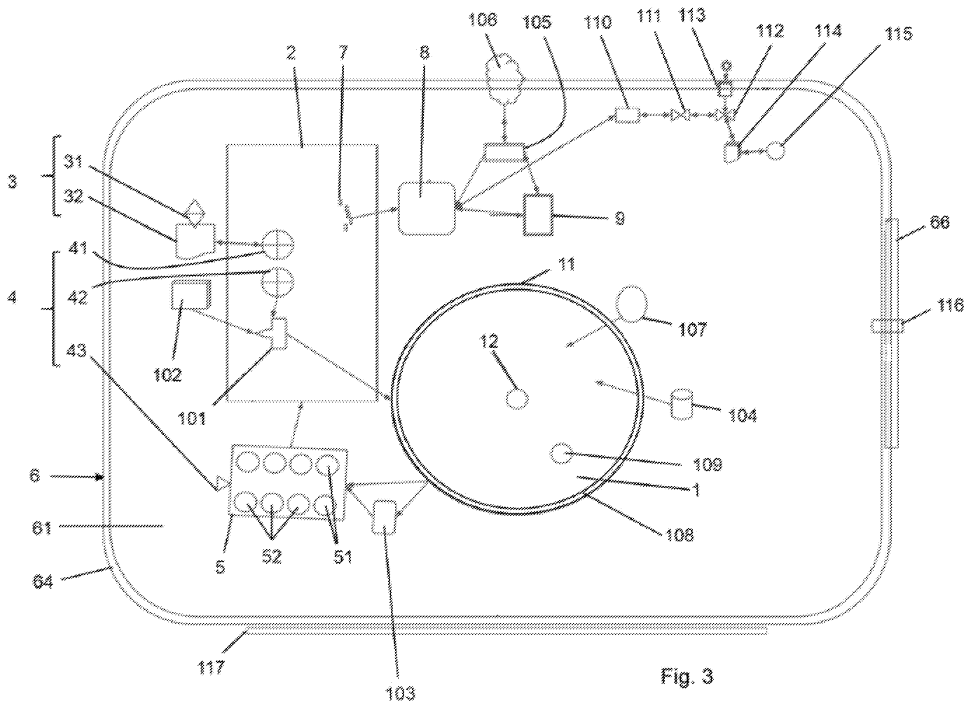

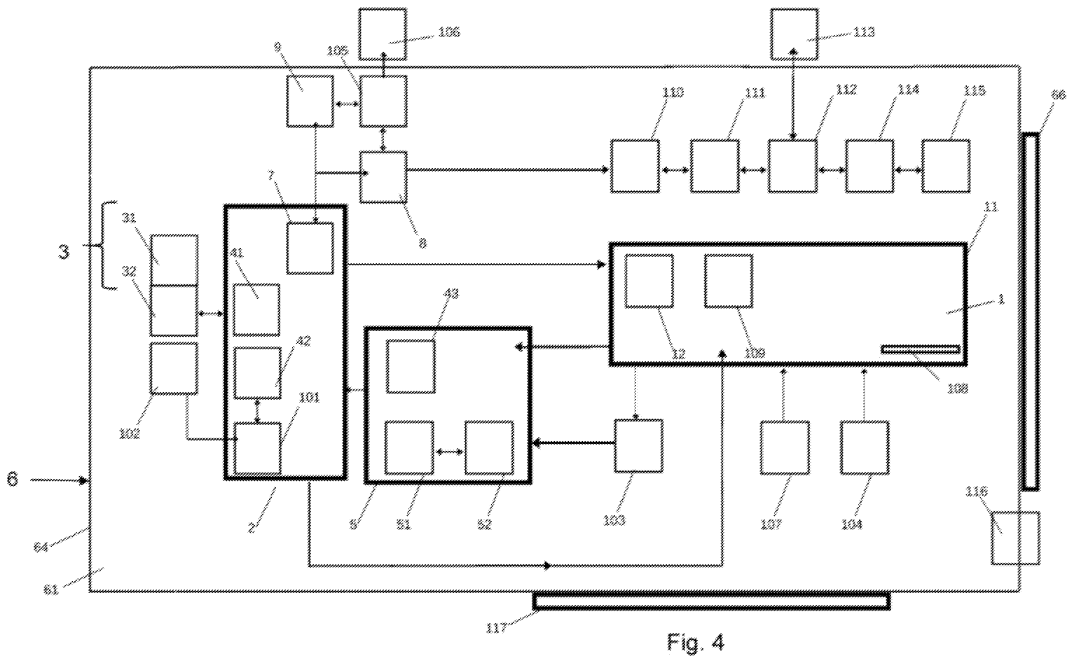

FIG. 3 shows a schematic diagram, FIG. 4 a circuit diagram of the essential components of one embodiment of the recirculating culture system according to the invention.

The spatial arrangement and proportions are not shown true to scale.

The recirculating culture system comprises a recirculating system and a container 6. The container 6 encloses an internal space 61, in which all essential components of the recirculating system are arranged. The essential components of the recirculating system are a culture pool 1, having a preferably transparent pool wall 11, a water reservoir 2, a temperature-control device 3, a pump system 4 and a filter system 5.

Aquatic organisms are accommodated in the culture pool 1. The culture pool 1 has a drain 12, through which fluid can be drained from the recirculating culture system if required. The drain 12 is preferably arranged centrally in the bottom of the culture pool 1, with the bottom of the culture pool preferably lowering in a funnel shape towards the drain 12.

The fluid present in the recirculating system is pumped by means of a pump system 4 from the culture pool 1, via the filter system 5 into the water reservoir 2 and from there back into the culture pool 1. For this purpose, the pump system 4 has a main pump 42. The main pump 42 connected to a venturi nozzle 101, via which the fluid in the water reservoir 2 is passed through an oxygen concentrator 102 as required.

Furthermore, the pump system 4 has a temperature-control pump 41 which pumps the fluid present in the water reservoir through the temperature-control device 3. The temperature-control device 3 has a heating rod 31 and a cooler 32. Heating rod 31 and cooler 32 are switched on as required. Oxygen is added to the fluid in the filter system 5 as required via an oxygen pump 43.

In the embodiment shown, the filter system 5 has 8 filters, two of which are anaerobic bio filters 51 and six of which are aerobic biofilters 52. The fluid in the recirculating system is pumped from the culture pool 1 into the two anaerobic biofilter chambers. The fluid is further pumped from the two anaerobic biofilter chambers through the six aerobic biofilter chambers and from the six aerobic biofilter chambers into the water reservoir.

A waste disposal unit 103 is further connected to the culture pool 1. The waste disposal unit 103 is a shredder that shreds and crushes coarser materials such as uneaten feed and other floating large particles. The shredded particles can then be broken down by biological processes in the filter system 5.

An automatic feed supply unit 104, which is used to supply feed into the culture pool, is located in the lid of the tank 6.

Most of the sensors of the sensor system 7 are arranged in the water reservoir 2. Notwithstanding the illustration, additional sensors may be arranged in the culture pool 1 or in the internal space 61 of the reservoir 6. These may be, for example, one or more than one temperature sensor, one or more than one oxygen sensor, one or more than one flow sensor, and one or more than one pH sensor. Other sensors may include a motion sensor preferably disposed in the lid of the vessel 6, water-level sensors disposed in the culture pool and/or water reservoir, light sensors disposed in the vessel, and other sensors described above.

The sensor system 7 transmits sensor data to a control device 8. The control device 8 controls the individual pumps of the pump system 4, the temperature-control device 3, the device for the feed supply unit 104 and a device (not shown) for salt enrichment of the fluid. For this purpose, the control device has a processing program that evaluates the sensor data and compares them with empirical values and/or predetermined set values.

The control device 8 also sends information about state parameters of the recirculating culture system to a display device 9, which is preferably a human machine interface or display (e.g., tablet). The display device 9 may be located directly on the exterior of the container 6. Both the control device 8 and the display device 9 may communicate with a cloud 106 via a gateway 105.

A camera 107 captures the interior of the culture pool 1. The image data from the camera 107 can be directly evaluated by the control device 8 and taken into account for control purposes and/or transferred to the display device 9.

A lighting device 108 can be used to illuminate the interior of the culture pool 1. The lighting device 108 can also be controlled by the control device 8. The lighting device 108 can be arranged at the upper pool edge of the culture pool 1 or in the lid 63 or in the internal space 61 of the container 6. In the embodiment shown, the lighting device 108 is designed in the form of a light tube at the upper pool edge of the culture pool 1. Alternatively, it may be in the form of one or more than one lamp or in a similar form.

A light opening 109 is further arranged in the lid 63 to allow daylight to enter the interior of the culture pool 1. The light opening 109 can be omitted in other embodiments.

The power supply is controlled via an electrical control panel 110. A charge controller 112 is connected to the electrical control panel 110 via an inverter 111. A solar panel 113 arranged on the outside of the container 6, preferably on the lid 63, is connected to the charge controller 112. Also connected to the charge controller 112 is a battery 114 which can be charged via a socket 115.

The container wall 64 of the container 6 is interrupted at one point by an opening which is not shown. In the area of this opening, the lid has a web 66 which serves to seal off the area above the opening.

The container 6 can have further openings (not shown) in its container wall 64 and/or in the lid, for example for supply air and/or exhaust air.

The lid is preferably closed in the area of the web 66 via an RFID lock 116.

An advertising wall 117 is arranged on the outside of the container 6. This can display advertising in digital or analog form.

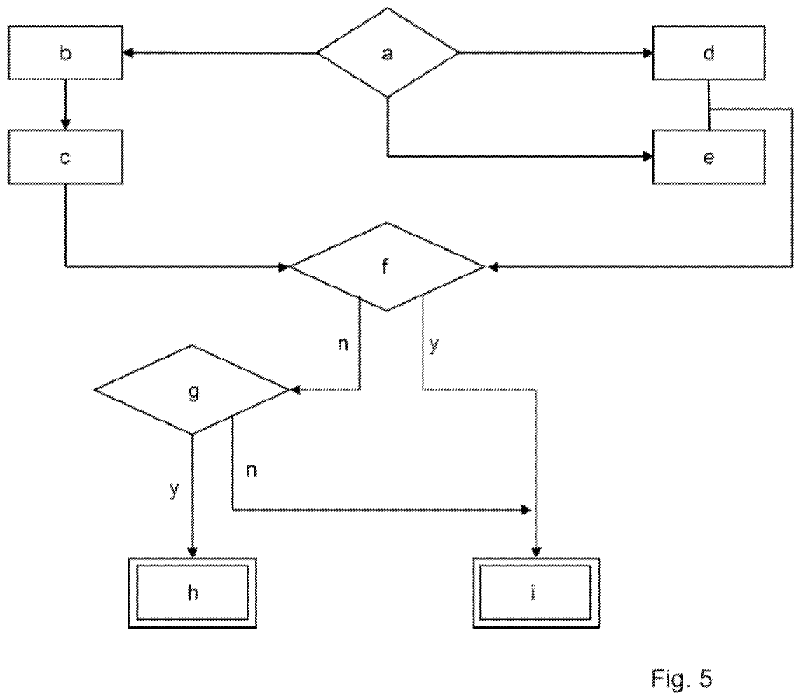

FIG. 5 shows a schematic representation of an embodiment of a method for the cultivation of aquatic organisms, as it can be carried out by means of the recirculating culture system according to the invention.

The starting point is the recirculating culture system a. The aquatic organisms to be cultured are introduced b. Husbandry data specific to the introduced organisms, such as program parameters for the specific species, behavioral data of the currently introduced animals, or previous husbandry data are entered as organism-specific program parameters c (initial value) into the control device of the recirculating culture system or are already entered at the factory. The control device also receives data relating to the parameters of the culture pool d (temperature, oxygen content, pH, etc.) and the environmental parameters e (outside temperature, light exposure, etc.). The control device compares the organism-specific program parameters c with the parameters of the culture pool d and the environmental parameters e. If the parameters of the culture pool d, influenced by the environmental parameters e, correspond to the initial values (organism-specific program parameters c), represented in FIG. 4 by a “y” for yes, then the control device regulates a further husbandry/breeding with the previous initial values. If the parameters of the culture pool d, influenced by the environmental parameters e, do not correspond to the initial values (organism-specific program parameters c), represented in FIG. 4 by an “n” for no, the algorithm of the control device makes the decision g whether the husbandry conditions should be adapted or not. If the decision is positive (y), the control device regulates a further husbandry/breeding h with new initial values. If the decision is negative (n), the control device controls a further husbandry/breeding i with the previous initial values.

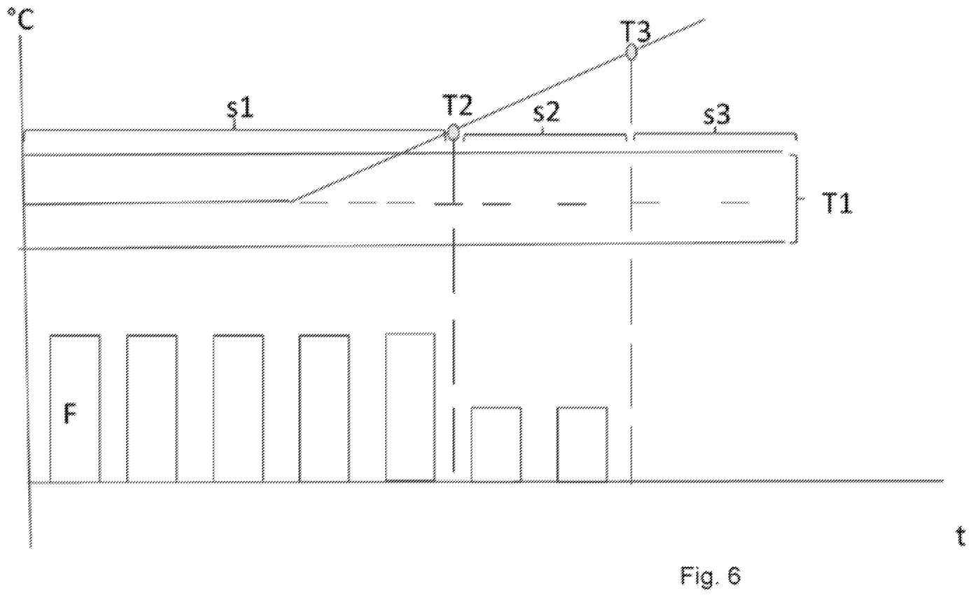

FIG. 6 shows a schematic representation of the feed quantity adjustment using the example of increasing temperature in the culture pool when keeping rainbow trout.

The temperature is plotted on the C axis and the time on the t axis. T1 shows the optimum temperature range. In the first period s1, the feed supply F is carried out at regular intervals, with a total of 100% of the set daily quantity, and this is not interrupted even if the temperature rises slightly. The second period s2 starts as soon as the first threshold point T2, i.e. a certain temperature value, has been exceeded and the feed supply is reduced by 50%. The third period s3 starts as soon as the second threshold value T3 has been exceeded, whereupon the feed supply is interrupted until the temperature is in the optimum range. From the period s2, the light can be additionally dimmed.

Values for the threshold points can be taken from the exemplary embodiment described above. As described further above, additional alarm measures, which are not shown in this scheme, can be initiated in the period s2 and s3.

### LIST OF REFERENCE NUMERALS

1 Culture pool

2 Water reservoir

3 Temperature-control device

4 Pump system

5 Filter system

6 Container

7 Sensor system

8 Control device

9 Display device

11 Pool wall

12 Drain

31 Heating rod

32 Cooler

41 Temperature-control pump

42 Main pump

43 Oxygen pump

51 Anaerobic biofilter

52 Aerobic biofilter

61 Internal space

62 Housing

63 Lid

64 Container wall

65 Opening

66 Web

101 Venturi nozzle

102 Oxygen concentrator

103 Waste disposal

104 Automatic feed supply unit

105 Gateway

106 Cloud

107 Camera

108 Lighting device

109 Light opening

110 Electric control panel

111 Inverter

112 Charge controller

113 Solar panel

114 Battery

115 Socket

116 RFID

117 Advertisement

611 First partial compartment

612 Second partial compartment

a Recirculating culture system

b Organisms to be cultivated

c Program parameters for organisms

d Parameters of the culture pool

e Environmental parameters

f Comparison by automatic program: Match with initial values?

g Decision by program automation: Adapting the husbandry environments?

h Further husbandry with new initial values

i Further husbandry with previous initial values

s1 Period 1

s2 Period 2

s3 Period 3

t Time axis

C Temperature axis

T1 Optimal temperature range

T2 First threshold

T3 Second threshold

F Feed rattans

1-18. (canceled)

19. Recirculating culture system for automatic cultivation and/or breeding of aquatic organisms, comprising
a recirculating system for circulating and controlling the temperature of a fluid, wherein the recirculating system comprises a culture pool (1) for receiving the fluid, a water reservoir (2) for storing the fluid, a temperature-control device (3) which is adapted to supply thermal energy to and/or extract thermal energy from the fluid, a pump system (4) for circulating the fluid, and a filter system (5) for filtering the fluid, as well as
a container (6), which has at least one internal space (61) and one or more than one container wall (64) which is penetrated by an opening (65), wherein the opening (65) and the culture pool (1) are adapted relative to one another in such a way that the culture pool (1) covers the opening (65) when arranged in the container (6), wherein the one or more than one container wall (64) comprises or is formed from an insulating material,
wherein the recirculating system is arranged in the at least one internal space (61) of the container (6), wherein the recirculating culture system further comprises:
a camera (107) whose field of detection is located inside the culture pool (1);
a sensor system (7) which is arranged in the at least one internal space (61), wherein the sensor system (7) comprises a temperature sensor, an oxygen sensor, a flow sensor, a conductivity sensor, and/or a pH sensor; and
a control device (8) in the internal space (61), wherein the control device (8) is arranged to control the recirculating system on the basis of data from the sensor system (7).

20. Recirculating culture system according claim 19, wherein the container (6) comprises a housing (62) and a lid (63).

21. Recirculating culture system according to claim 20, characterized in that one or more movement and/or pressure sensors are arranged in the lid (63), which detect whether the lid (63) is in an open or a closed state.

22. Recirculating culture system according to claim 19, wherein the culture pool (1) comprises a transparent basin wall (11) covering the opening (65).

23. Recirculating culture system according to claim 19, wherein the control device (8) further adjusts the control of the recirculating system based on stored user data and/or recorded experience values and/or programmed target values.

24. Recirculating culture system according to claim 19, further comprising a display device (9) attached to and/or integrated with an exterior of the container (6), wherein the control device (8) is further adapted to output, by means of the display device (9), one or more indications of a system state of the recirculating system.

25. Recirculating culture system according to claim 24, wherein the display device comprises at least three, preferably at least five, more preferably at least 10, touch-controlled light components.

26. Recirculating system according to claim 24, wherein the display device comprises more than two LED panels.

27. Recirculating culture system according to claim 19, wherein the control device (8) is further adapted to generate and/or transmit a message according to a network communication protocol, wherein the message comprises one or more than one indication of a system state of the recirculating system and/or is addressed to a mobile and/or digital terminal.

28. Recirculating culture system according to claim 19, wherein the filter system (5) comprises one or more than one anaerobic biofilter (51) and one or more than one aerobic biofilter (52).

29. Recirculating culture system according to claim 19, wherein the one or more than one anaerobic biofilter (51) comprises two or more than two anaerobic biofilter chambers, and wherein the one or more than one aerobic biofilter (52) comprises six or more than six aerobic biofilter chambers.

30. Using a recirculating culture system according to claim 19 for the automatic cultivation and/or breeding of aquatic life.

31. Method for the automatic operation of a recirculating culture system according to claim 19, the method comprising:
introducing aquatic life into the recirculating culture system
bringing the recirculation system to an operating point in accordance with a prerequisite for cultivating and/or breeding aquatic organisms, such that the recirculating system temperature-controls, recirculates, and/or oxygenates the fluid;
automatically executing one or more stocking cycles for the breeding/husbandry of aquatic organisms via an automatic program; and
controlling a temperature-control device by a control device in the event of a temperature change registered inside the container and/or on the exterior of the container in order to automatically cause heating or cooling of the fluid in the recirculating system.

32. Method according to claim 31, wherein a control device brings the recirculating culture system to the operating point according to a prerequisite for cultivating and/or breeding the aquatic organisms.

33. Method according to claim 31, wherein the recirculating culture system for automatic; fish husbandry is preferably designed according to a predetermined processing program, wherein the husbandry parameters and/or an environmental condition can be measured with regard to condition parameters or can be entered as value(s).

34. Method according to claim 31, wherein the control device directly responds to changing process and/or environmental conditions of the recirculating culture system without requiring intervention and regulation by a user.

35. Method according to claim 34, wherein the control device adjusts the control of the recirculating system based on stored user data and/or recorded experience values and/or programmed target values.
